(19) United States
(12) Patent Application Publication
(10) Pub. No.: US 2010/0005503 A1
(43) Pub. Date: Jan. 7, 2010

(54) SYSTEMS AND METHODS FOR GENERATING A VIDEO IMAGE BY MERGING VIDEO STREAMS

(76) Inventors: Floyd W. Kaylor, Yorba Linda, CA (US); Brick Rucker, Los Angeles, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/166,217

(22) Filed: Jul. 1, 2008

(51) Int. Cl. H04N 7/16; H04N 5/44

(52) U.S. Cl. 725/139; 348/734; 348/E05.096

(57) ABSTRACT

According to various embodiments of the invention, a system is provided for working with multimedia content. In some embodiments, the system comprises a video box configured to receive video content from a first and a second source and generate active content by merging the video content from the first and second sources. Additionally, various embodiments may include a spatial television remote control including an accelerometer. This accelerometer may be coupled to a processor so that the processor can process signals from the accelerometer to provide a cursor-pointing function based on movement of the remote control.

### TECHNICAL FIELD

The present invention relates to video systems, and more particularly, some embodiments relate to systems and methods that generate video images by merging video streams.

### DESCRIPTION OF THE RELATED ART

Video content can be provided to users from a multitude of different sources. For example, television programming may be received by a television using broadcast television signals, satellite television signals or cable television signals. Broadcast television signals can include traditional analog television transmissions or digital television transmissions.

In the Unites States, on Feb. 17, 2009, it is planned that all full-power television broadcast stations will stop broadcasting in analog format and broadcast only in digital format. Congress mandated this conversion from analog to digital because digital broadcasting will free up frequencies for public safety communications such as police, fire, and emergency rescue. Additionally, digital television broadcasting is a more efficient transmission technology. It is also believed that digital television broadcasting will allow broadcast stations to offer improved picture and sound quality, as well as more programming options for consumers through multiple broadcast streams, e.g., multicasting. In addition to public safety communications, some of the freed up frequencies will be used for advanced commercial wireless services for consumers.

Similar to broadcast television, satellite television signals may also be transmitted using analog or digital transmissions. These systems may generally provide television services over a wider area because broadcast television is usually limited to line-of-sight. The television satellites are typically in geosynchronous orbit. This means that they stay in one place in the sky relative to the Earth. This allows a satellite dish to be pointed at a location in the sky and to receive a satellite signal without requiring the dish to be moved to track the satellite.

Cable television signals can be transmitted to a television using cables. These cables might be wires, fiber optics, etc. The programming may include broadcast television networks, cable television channels, local-access television channels, and premium networks, as well as “pay-per-view” and “on-demand” programming.

Additionally, video content may be retrieved over the internet or other computer network. For example, many different video sharing sites are available on the internet. Video content may be downloaded, e-mailed, saved to disk, etc. This content may, for example, be viewed using a television or a computer and may be stored on various other electronic devices. Given the large number of available sources of video content, a system that allows a user to access, save, view, process and combine this content can provide heretofore-unavailable video processing functionality.

Additionally, many modern televisions include functions not present in older models. In some cases, these functions may be controlled by menus and submenus that are used to access this functionality. Further, in addition to being used to watch television, DVDs, or other traditional television video content, some of these televisions may be used to access the internet, edit various video content, and perform other tasks. For example, in some cases, modern televisions may be connected to one or more computers to act as the computer's monitor.

In many cases, it might be convenient for a user to access one or more of these various functions using a mouse. In some cases, however, a user might not have access to a hard surface to place the mouse on. For example, a television might be placed in a living room or bedroom, rather than an office. Further, the user might wish to control the television from a couch or bed and might not have access to a table, desk or other hard surface from such a location. Additionally, the user might prefer to control the television with a device that does not need such a surface to operate.

### BRIEF SUMMARY OF EMBODIMENTS OF THE INVENTION

According to various embodiments of the invention, a system is provided for working with multimedia content. In some embodiments, the system comprises a video box configured to receive video content from a first and a second source and generate an active content by merging the video content from the first and second sources. Additionally, various embodiments may include a spatial television remote control. The remote control may include an accelerometer. This accelerometer may be coupled to a processor so that the processor can receive signals from the accelerometer to provide a cursor-pointing function. This pointing function can be based on movement of the remote control. In some embodiments, a keypad can also be coupled to the processor and configured provide inputs to the processor. Additionally, in various embodiments, a transmitter can be coupled to the processor and configured to transmit television control signals, including cursor-pointing functions. Various embodiments may include methods of using a multimedia system that includes a spatial remote control.

According to one embodiment of the system and methods described herein, one source of video content may comprise one type of content, while another source may comprise another type of content, for example, one source may be internet video content while another is broadcast television. Other sources of video content may also be available and processed in some embodiments. For example, video content may include broadcast television, satellite television, fiber optic television, cable television, etc.

In some embodiments, the system further comprises a sensor bar. The sensor bar may include a plurality of light emitting diodes, wherein at least one diode points at a different angle from another diode. An optical sensor can receive signals from these diodes. This optical sensor can be part of a spatial remote. Inside the remote, the sensor is coupled to the processor, and is configured to receive signals from the sensor bar and determine pointing based on the received signals.

In some embodiments, the accelerometer in the television remote is configured to sense acceleration along three axes. This may also allow the device to function as a pointer as well as a motion-sensing device. Various embodiments include both a three axes accelerometer and an optical sensor. In such devices, inputs from the optical sensor and the accelerometer might be combined to determine pointing direction.

The spatial remote may function as a universal remote. In other words, the spatial remote may be programmable by a user to operate at least two brands of consumer electronic devices.

In some embodiments, the transmitter of the spatial television remote comprises an infrared transmitter. In other embodiments, the transmitter of the television remote comprises a radio frequency transmitter. When a radio frequency transmitter is used, the remote can be configured to operate as a Bluetooth® device, 802.11(x) device or other radio frequency device, including other standards and possibly proprietary systems. Additionally, in some embodiments, the television remote may further comprise a display.

Some embodiments relate to a method of using various multimedia systems built according to the systems and methods described herein. This method can include detecting active content, selecting an area of interest using a spatial television remote control and displaying internet content regarding the area of interest based on the input from the television remote control. Additionally, in some embodiments, the television remote control may be used to navigate the internet content and provide inputs from the user to the internet site from the television remote control.

Various embodiments of this method may use radio frequency signals or infrared signals to transmit from the television remote. Additionally, some embodiments use a remote with an optical sensor to determine where the television remote is pointing. This remote may be used in conjunction with a sensor bar to determine where the television remote is pointing.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an example video box in accordance with the systems and methods described herein.

FIG. 2 is a diagram illustrating an example spatial television remote control in accordance with the systems and methods described herein.

FIG. 3 is a flowchart illustrating an example method in accordance with the systems and methods described herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

According to various embodiments of the invention, a system is provided for working with multimedia content. In some embodiments, the system comprises a video box configured to (i) receive video content from a first and a second source and (ii) generate an active content by merging the video content from the first and second sources. Additionally, various embodiments may include a spatial television remote control. The remote control may include an accelerometer. This accelerometer may be coupled to a processor so that the processor can process signals from the accelerometer to provide a cursor-pointing function. The pointing function may be based on movement of the remote control. In some embodiments, a keypad can also be coupled to the processor and configured provide inputs to the processor. Additionally, in various embodiments, a transmitter can be coupled to the processor and configured to transmit television control signals, including cursor-pointing functions.

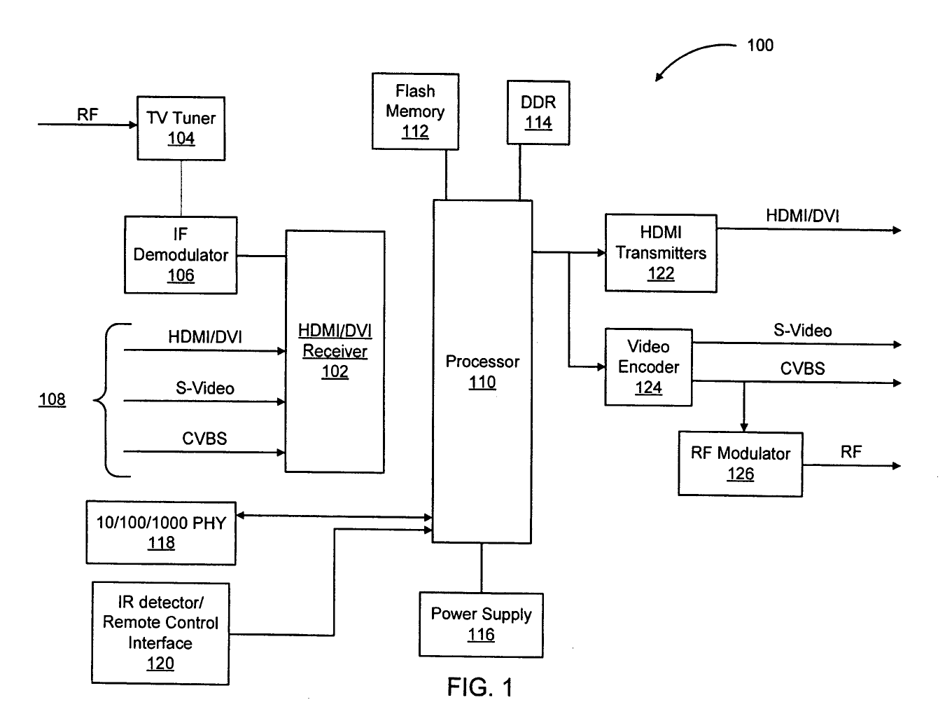

FIG. 1 is a diagram illustrating an example video box 100 in accordance with the systems and methods described herein. Referring now to FIG. 1, video box 100 includes an HDMI/DVI receiver 102. The receiver 102 is coupled to a television tuner 104 through an intermediate frequency demodulator 106. Accordingly, the receiver can receive radio frequency television signals. Additionally, the receiver can receive other signals 108, such as HDMI/DVI, S-Video and CVBS.

In some embodiments, the video box 100 can receive inputs such as High-Definition Multimedia Interface (HDMI). These may include the following audio signals, without limitation: PCM, DVD-Audio, Super Audio CD, Dolby TrueHD, DTS-HD Master Audio. Additionally, some embodiments can receive the following video signal resolutions: 480i, 480p, 576i, 576p, 720p, 1080i, 1080p, 1440p, 1600p; at bandwidth up to 10.2 Gbit/s at 340 Mpixel/s using the TMDS protocol. The video box 100 can also receive Digital Visual Interface (DVI) with single video streams up to WUXGA 1920×1200 pixel resolution at 60 Hz, and dual streams up to WQXGA (2560×1600) pixel resolution at 60 Hz.

In other embodiments, inputs such as radio frequency modulated, Separate Video (S-Video), Cable In (DOCSIS), National Television System Committee (NTSC), Internet Content, HDMI and DVI can also be received. In various embodiments, HDMI and DVI inputs are processed by a 165 MHz receiver that sends the signal for audio and video packet processing. The results of the packet processing of the HDMI or DVI signal are a separate audio signal over I2S or Sony Philips Digital Interface (SPDIF) protocol, and a separate video signal in either 8-bit BT656 protocol, 12-bit Double-Data Rate (DDR), 16-bit High-Definition (HD), or 24-bit RGB format. Any overlay of graphics on the video signal can be output as 24-bit RGB.

In some embodiments, Radio Frequency Modulated and S-Video signals are taken through an analog-to-digital converter sampling at 150 MHz, and further processed to output a video signal in either 8-bit BT656 protocol, 12-bit Double-Data Rate (DDR), 16-bit High-Definition (HD), or 24-bit RGB format.

Additionally, in various embodiments Cable In (DOCSIS) and NTSC may be used. For example, “hotspotting” may be performed at the time of video production with respect to video content that is not already embedded with web-links. Hotspotting is a process, wherein links, such as internet content, are added to the video. For these applications, the video box 100 can process video inputs over cable television and NTSC radio frequency signals, and then overlay web graphics as static content onto the video.

In some embodiments, these web graphics are output as 24-bit RGB. The cable television and NTSC radio frequency signal inputs are processed by an NTSC/Cable TV demodulator, which combines a digitally programmable phase locked loop (PLL), with a mixer-oscillator block including two balanced mixers and oscillators. Additionally, the PLL block with four selectable chip addresses forms a digitally programmable phase locked loop.

In some embodiments, an internet connection may provide various inputs. For example, the video box 100 may integrate features that allow connection to Local Area Networks (LANs) at 10BASE-T, 100BASE-T, and 1000BASE-T Ethernet protocols 118. This connection to the internet allows the video box 100 to process streaming video over Ethernet to be displayed to the viewer. The internet connection also allows interactive commands to be sent to a main server where the interactive functions are processed.

In some embodiments, the video box 100 can be controlled by a remote control. For example, the remote control may be an infrared or radio frequency remote. The signals from such a remote can be received by remote control interface 120, which is coupled to processor 110.

The processor 110 can be a microprocessor, microcontroller, discrete logic, programmable logic, an ASIC, etc. Additionally, the processor 110 is coupled to flash memory 112 and DDR memory 114 that may provide program and data storage, respectively, for the processor. Additionally, power supply 116 can provide power to the processor 110 and various other components in the video box 100.

The processor 110 is coupled to an HDMI transmitter 122 and a video encoder 124. The HDMI transmitter can provide a High-Definition Multimedia Interface (HDMI) and a Digital Visual Interface (DVI). Without limitation, the HDMI may have the following audio signals: PCM, DVD-Audio, Super Audio CD, Dolby TrueHD, DTS-HD Master Audio; and the following video signal resolutions: 480i, 480p, 576i, 576p, 720p, 1080i, 1080p, 1440p, at bandwidth up to 10.2 Gbit/s at 340 Mpixel/s using the TMDS protocol. The DVI can have a single video streams up to WUXGA 1920×1200 pixel resolution at 60 Hz, and dual streams up to WQXGA (2560×1600) pixel resolution at 60 Hz.

In various embodiments, the video encoder may output S-Video or CVBS. Additionally, the CVBS signal can be coupled to a radio frequency modulator 126 which outputs radio frequency signals that may, for example, be received over the antenna port of a television. In various embodiments, other outputs of the video box 100 may include Composite Video (YPrPb), Component (RGB), National Television System Committee (NTSC). In some embodiments, the HDMI and DVI outputs are generated by a 165 MHz, HDMI v. 1.3 compliant transmitter that allows secure transmission of protected content as specified by the HDCP v. 1.2 protocol. 8-channel I2S audio is transmitted in stereo or 7.1 surround audio at 192 kHz. The S/PDIF can carry stereo LPCM audio or compressed audio, including DTS®, THX®, and Dolby® Digital. Video data are captured and processed through a color conversion. The video data can include digital input in RGB or YCbCr format, clock input supporting CMOS logic levels from 1.8 volts to 3.3 volts, horizontal synchronization, vertical synchronization and data enable bits for digital video. The result is a differential clock output at pixel clock rate, differential output of the red data at 10× the pixel clock rate, differential output of the green data at 10× the pixel clock rate, and differential output of the blue data at 10× the pixel clock rate, each at TMDS logic level.

In various embodiments, S-Video, Composite Video (YPrPb), and Component RGB outputs are generated by an internal video encoder that uses six 11-bit digital to analog converters and a 24-bit pixel port to provide Standard Definition, Enhanced Definition, and High Definition video formats.

In some embodiments, a radio frequency modulated output is generated by a Phase Locked Loop (PLL) tuned, Very High Frequency (VHF), audio/video (A/V), high integration modulator. This modulator may be compatible with the National Television System Committee (NTSC) format. The radio frequency output power level is typically between 76 dBμV and 80 dBμV.

In various embodiments of the systems and methods described herein, interactive media content is embedded with special codes at the time of video production. This content may be transmitted to the video box 100 over HDMI, DVI, S-Video, or Ethernet 108. The video box 100 can receive content that was not embedded with special codes for hotspotting during production. Additionally, in some embodiments, the video box 100 transmits interactive media content as a digital stream to the viewer's display.

In some embodiments, the video box 100 transmits interactive media content as an analog stream to the viewer's display. Additionally, the spatial remote may be used as the viewer interface to the interactive media content. Interactive commands regarding web-based hotspots embedded in the interactive media content may be recognized at the video box 100 and sent over Ethernet to a main server.

In various embodiments, interactive functions that are associated with the interactive media content may be performed and processed at the main server. Additionally, the interactive media content may be embedded with special codes at the time of video production.

In some embodiments, the interactive media content can be the interactive media program that operates with the video box 100, remote, and ad model. The interactive media content can be embedded with codes that allow the streaming of the media player over Ethernet. Additionally, interactive media content may be transmitted to the video box over HDMI, DVI, S-Video, or Ethernet. Accordingly, the video box 100 may receive content that was not embedded with special codes for hotspotting during production.

In some embodiments, the video box 100 may transmit interactive media content as a digital stream to the viewer's display. In other embodiments, the video box may transmit the interactive media content as an analog stream to the viewer's display. The video box 100 may also transmit interactive media content as a digital and an analog stream to the viewer's display.

Additionally, interactive commands regarding web-based hotspots embedded in the interactive media content may be recognized at the video box 100 and sent over Ethernet to the main server. Additionally, interactive functions that are associated with the interactive media content may be performed and processed at the main server.

Some embodiments of the systems and methods described herein may include a media player that includes various functionality. This functionality can include, but is not limited to: Play/Pause/Rewind/Fast Forward video content, volume control, timeline control (skip to anywhere in the content), full screen mode, index menu of all hotspotted content contained within video stream, a player help menu and a menu button for additional functionality and future expansion.

The media player may also have the ability to display a content panel. This content panel can include an expanded content panel, or overlay or constant content panel that is always present. Additionally, the media player can display the hotspot or timeline marker content, embed on any webpage with HTML embed code, send a player embed code to an email address and switch between passive and active mode.

In some embodiments, the media player may set whether or not hotspot content automatically displays or briefly indicates hotspot areas. It can also display still images as a book reader, e.g., book pages and insert traditional video ads. Additionally, some media players can process pre/post roll ads and act as an overlay unit. In this way, the device can be used for user customization, for example, for the purposes of branding.

Some embodiments include media players that include support for 4:3 and 16:9 aspect ratios at varying widths, are high definition capable, have the ability to insert watermarks, have the ability for viewers to rate the program content or perform a live chat functionality

Various embodiments of the systems and methods described herein include a content authoring system such as a web interface that may include an authoring system functionality. These embodiments may have the ability to login via a proprietary web interface, upload video formats: FLV, MPEG, AVI, MOV, convert uploaded video formats to FLV and create media (panels) to assign to hotspots.

Additionally, some embodiments may include content panels. These panels can contain additional video, images, Flash or eCommerce widgets. Additionally, in some embodiments, user can use a WYSIWYG “what you see is what you get” type editor to type in content if so desired. User can also choose the type of panel. For example, the panel may be overlay, slide in/out, link out to a site or popup mini-sites. The panel can also be continuous, e.g., always present next to video. Additionally, users may have the ability to set an impression number or time based display to a panel in some embodiments.

Some embodiments include various interactive videos functionality. For example, some embodiments may include uploaded video with hotspots, timeline based triggers, content triggers and scan through uploaded video, similar to a video shuttle. Additionally, in some embodiments users can create and customize the media player. Further, some embodiments provide the ability for authors to create multiple media players. For example, a user might select a ratio, name a player, customize the width, etc. Screen height can be determined by the ratio selected. Additionally, each player may have her own unique ID.

Various embodiments can auto-generation embedded code that may allow authors to customize the appearance of the media player. In some embodiments these authors may use, for example, colors, fonts, upload button images, upload skins, such as texture maps, video project creation functionality, etc.

Additionally, in some embodiments, a user can create or name a program and enter video metadata. The metadata may include keywords, descriptions or an uploaded watermark. Various systems can schedule a program, upload video files and insert pre-roll, post-roll and overlay content. The pre-roll, post-roll and overlay content may include videos, images with a link and flash.

Various systems include the ability to drag in a shape from a tool pallet, place it on the video and assign an action to the shape. This assignment may be made by a click and mouse-over, for example, using a mouse, track ball, or other devices, such as the spatial television remote control.

Some embodiments include the ability to assign a content panel to a shape and the ability to limit access to the program. Access can be limited by requiring a username and password, requiring a credit card for pay-per-view, assigning a price for viewing, or by marking a program as premium.

The systems and methods described herein may include the ability to assign a content panel to a timeline marker or the ability to assign a program to a specific media player or players. Additionally, users may be able to save programs, post a demo for review or publish to web.

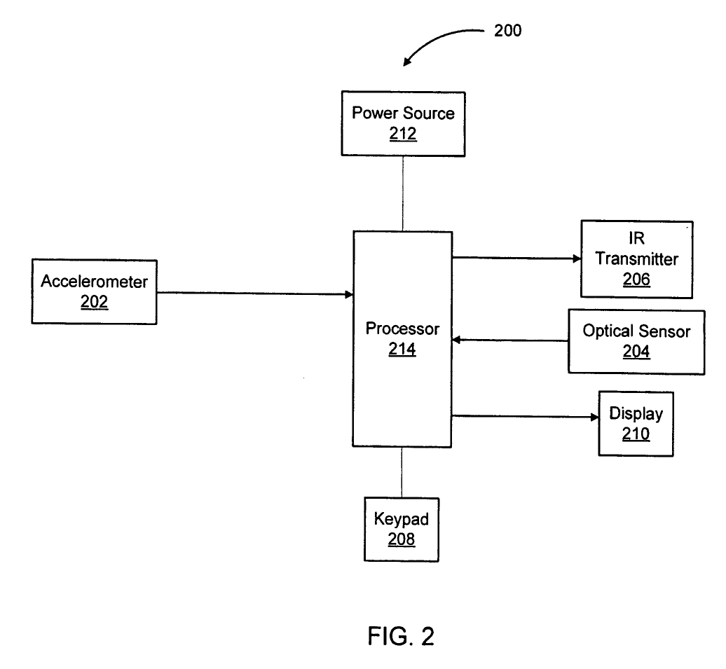

FIG. 2 is a diagram illustrating an example spatial television remote control in accordance with the systems and methods described herein. Referring now to FIG. 2, in some embodiments, the spatial television remote control 200 provides a cursor-pointing function. This function can be provided without requiring a hard surface, for example, as is generally required for a computer mouse. Additionally, in some embodiments, the spatial television remote control 200 may incorporate a “universal remote” functionality. A universal remote is a device that can usually be programmed by a user to control various brands of television. For example, a universal remote might be used to control a television from one manufacturer, a VCR from another manufacturer and a DVD player from a third manufacturer.

In some cases, low-end universal remotes can only control a set number of devices determined by their manufacturer, while mid- and high-end universal remotes allow the user to program in new control codes to the remote. Many remotes sold with various electronic devices include universal remote capabilities for other types of devices, which allow the remote to control other devices beyond the device it came with. For example, a VCR remote might be programmed to operate various brands of televisions.

In some embodiments, the communication between the spatial television remote control 200 and a video box may be wireless. For example, communication methods can be infrared, while in other embodiments it may be radio frequency. Generally, infrared is strictly line-of-sight, for example, to the video box. Accordingly, radio frequency methods might alleviate various issues if non-line-of-sight methods are desirable. Remotes 200 that communicate using radio frequency might implement Bluetooth®, 802.11(x), other radio frequency communication standard or a proprietary radio frequency communication architecture.

In various embodiments, the spatial television remote control 200 may be used to control a video box or other video based consumer electronics device. For example, spatial television remote control 200 might control a television directly. Additionally, it will be understood by those of skill in the art that the spatial television remote control 200 might control multiple device. 100601 In some embodiments, the spatial television remote control includes motion-sensing capability, which allows the user to interact with and manipulate items on screen via movement and pointing through the use of accelerometer 202 and optical sensor technology 204. For example, in some embodiments, the spatial television remote control has the ability to sense acceleration along three axes through the use of accelerometer 202. For example, some embodiments may use an ADXL330 accelerometer. The spatial remote also features an optical sensor 204, such as, for example, a PixArt optical sensor. The optical sensor 204 allows the spatial television remote control 200 to determine where it is pointing.

The remote 200 may sense light from a sensor bar. This sensor bar may be located on the video box, which allows consistent usage regardless of a television's type or size. In some embodiments, the sensor bar is about 20 cm (8 in) in length and may include ten infrared LEDs, with five LEDs being arranged at each end of the bar. Various LEDs can be pointed at different angles from other LEDs. For example, in some embodiments, in each group of five LEDs, the LED farthest away from the center is pointed slightly away from the center, the LED closest to the center is pointed slightly toward the center, while the three middle LEDs are pointed straight forward and grouped together. Additionally, in some embodiments, the sensor bar's cable can be 353 cm (11 ft 7 in) in length. The bar may be placed above or below the television, and may be centered. In some embodiments, the sensor bar is placed in line with the front of the television. Generally, it is not necessary to point directly at the sensor bar; however, pointing significantly away from the bar will generally disrupt position-sensing ability due to the limited viewing angle of the remote.

In various embodiments, use of the sensor bar allows the remote 200 to be used as an accurate pointing device, for example, up to 5 meters (approx. 16 ft) away from the bar. The remote's 200 image sensor may be used to locate the sensor bar's points of light in the remote's field of view. The light emitted from each end of the sensor bar may be focused onto the image sensor, which sees the light as two bright dots separated by a first distance on the image sensor. The second distance between the two clusters of light emitters in the sensor bar is a fixed distance. From these two distances the video box calculates the distance between the remote 200 and the sensor bar using triangulation. In addition, rotation of the remote 200 with respect to the ground may also be calculated from the relative angle of the two dots of light on the image sensor.

In some embodiments, the sensor bar can be used to point to menu options or objects when the remote 200 is controlling up-down, left-right motion of a cursor or reticule on the TV screen. Because the sensor bar also allows the remote to calculate the distance between the remote 200 and the sensor bar, the remote 200 can also control slow forward-backward motion of an object in a 3-dimensional game. Rapid forward-backward motion, such as punching in a boxing game, is controlled by the acceleration sensors. Using these acceleration sensors (acting as tilt sensors), the remote 200 can also control rotation of a cursor or other objects.

In some cases, the use of an infrared sensor to detect position can cause some detection problems when other infrared sources are around, such as incandescent light bulbs. In some embodiments, this can be alleviated by using fluorescent lights around the video box, since fluorescent lights emit little or no infrared light. Some embodiments use other sources of infrared light as a substitute for the sensor bar. For example, some embodiments use a pair of flashlights and a pair of candles. Such substitutes for the sensor bar illustrate that a pair of non-moving lights provide continuous calibration of the direction that the remote 200 is pointing and its physical location relative to the light sources.

In some embodiments, a remote control for an electronic appliance may use an infrared diode 206. For example, infrared diode 206 may be a near infrared diode, which may emit a beam of light that reaches the device or devices being controlled by the remote 200. In some embodiments, the infrared diode 206 can be a 940 nm wavelength LED. This infrared light is invisible to the human eye but carries signals that are detected by the appliance, as well as by the sensor of a digital camera. For example, the LEDs can be seen through some cameras and other devices with a higher visible spectrum than the human eye.

In some embodiments, the remote 200 includes a keypad 208 that can be used to input commands into the remote 200. These commands can then be transmitted to the device or devices that are being controlled by the remote 200. Additionally, some embodiments include a display 210. The display 210 can provide information to the user. For example, the display may indicate which commands have been selected on the keypad 208 or other information useful to the user. Additionally, in other embodiments, the display 210 may be a touch screen and might replace or supplement the keypad 208.

The remote 200 can be powered by a power source 212. By way of example, the power source may be one or more AA or AAA batteries. By using small batteries, the remote 200 might generally be made small, light and more easily portable.

The spatial television remote control 200 also includes a processor 214. The processor 214 controls the functionality of the remote 200 and can be a microcontroller, microprocessor, discrete logic, programmable logic, an ASIC, etc. The processor 214 can be powered by the power source 212, and receive input data from the accelerometer 202, optical sensor 204 and keypad 208. Additionally, the processor 214 can output signals to a transmitter 206 and a display 210. As discussed above, the transmitter 206 can be an infrared transmitter or a radio frequency transmitter. Additionally, in embodiments that use a touch screen, display screen 210 may provide an input to the processor 214. In some embodiments, the processor 214 may be an MCU, MC68HC05. Additionally, in various embodiments, the spatial television remote control 200 is expandable through the use of various attachments.

In some cases, the spatial television remote control may also be referred to as “remote control,” “remote,” “controller,” “spatial remote,” “television remote control,” “spatial television remote,” etc. Generally, remote controls are used to issue commands from a distance to televisions or other consumer electronics such as stereo systems VCRs and DVD players. Remote controls for these devices are usually small wireless handheld objects with an array of buttons for adjusting various settings such as television channels, track number, and volume. In many cases, modern devices may include a remote control that contains all the function controls while the controlled device only has a handful of essential primary controls. In general, most of these remote controls communicate to their respective devices via infrared signals, while a few may communicate via radio frequency signals.

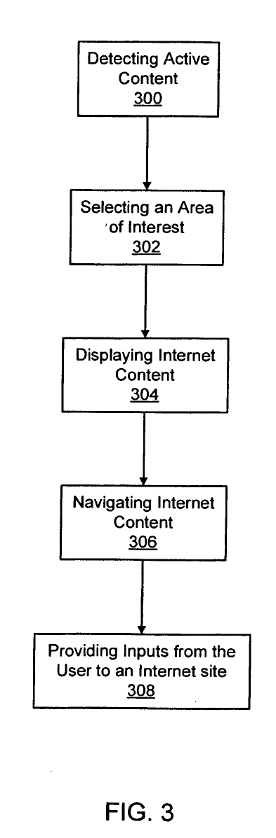

FIG. 3 is a flowchart illustrating an example method in accordance with the systems and methods described herein. Referring now to FIG. 3, in step 300, a device detects active content. In some embodiments, active content is content created when a first and second video signal are combined. For example, in some embodiments, internet video content may be combined with other video content to create the active content.

In step 302, a user selects an area of interest. For example, in some embodiments, a user can use a spatial television remote control to select an area. The area of interest can include internet content, links to additional internet content, such as web page links or links to other files, etc.

In step 304, internet content is displayed. In some embodiments, content based on the area of interest may be displayed. For example, if the area of interest is a link to a web page, the user selection in step 302 can cause the web page to be displayed. Other internet content might also be displayed in step 304. This content may be based on the area of interest selected in step 302.

In a step 306, a user navigates the internet using the systems and methods described herein. For example, the spatial television remote control might be used similar to a mouse to navigate the internet. In this way, a user can “surf” the internet without needing a flat surface with which to use a mouse. In some embodiments, a user can surf the internet using the spatial remote, video box and a television, while sitting on a couch or laying in bed.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A multimedia system comprising:
a video box configured to:
receive video content from a first source;
receive video content from a second source; and
generate an active content by merging the video content from the first source and the second source; and
a spatial television remote control including:
an accelerometer;
a processor, coupled to the accelerometer and configured to process signals from the accelerometer to provide a cursor-pointing function based on movement of the remote control;
a keypad, coupled to the processor and configured provide inputs to the processor;
a transmitter, coupled to the processor and configured to transmit television control signals, including cursor-pointing functions.

2. The multimedia system of claim 1, wherein the first and second source comprises different types of video content.

3. The multimedia system of claim 1, wherein the system further comprises a sensor bar.

4. The multimedia system of claim 3, wherein the sensor bar includes a plurality of light emitting diodes, wherein at least one diode points at a different angle from another diode.

5. The multimedia system of claim 1, wherein the television remote further comprises an optical sensor coupled to the processor and configured to receive signals from the sensor bar and determine pointing based on the received signals.

6. The multimedia system of claim 1, wherein the television remote comprises a universal remote that can be programmed by a user to operate at least two brands of consumer electronic devices.

7. The multimedia system of claim 1, wherein the transmitter of the television remote comprises an infrared transmitter.

8. The multimedia system of claim 1, wherein the transmitter of the television remote comprises a radio frequency transmitter.

9. The multimedia system of claim 8, wherein the television remote is further configured to operate as a Bluetooth® device.

10. The multimedia system of claim 8, wherein the television remote is further configured to operate as an 802.11(x) device.

11. The multimedia system of claim 1, wherein the television remote further comprises a display.

12. The multimedia system of claim 1, wherein the accelerometer in the television remote is configured to sense acceleration along three axes.

13. A spatial television remote control comprising:
an accelerometer;
a processor, coupled to the accelerometer and configured to process signals from the accelerometer to provide a cursor-pointing function based on movement of the remote control;
a keypad, coupled to the processor and configured provide inputs to the processor;
a transmitter, coupled to the processor and configured to transmit television control signals, including cursor-pointing functions.

14. The television remote of claim 13, wherein the remote comprises a universal remote that can be programmed by a user to operate at least two brands of consumer electronic devices.

15. The television remote of claim 13, wherein the transmitter comprises an infrared transmitter.

16. The television remote of claim 13, wherein the transmitter comprises a radio frequency transmitter.

17. The television remote of claim 16, wherein the remote is further configured to operate as a Bluetooth® device.

18. The television remote of claim 16, wherein the remote is further configured to operate as an 802.11(x) device.

19. The television remote of claim 16, wherein the remote is further configured to operate as a Bluetooth® device.

20. The television remote of claim 13, further comprising a display.

21. The television remote of claim 13, further comprising an optical sensor coupled to the processor and configured to receive signals from a sensor bar and determine pointing based on the received signals.

22. The television remote of claim 13, wherein the accelerometer is configured to sense acceleration along three axes.

23. A method of using a multimedia system comprising:
detecting active content;
selecting an area of interest using a spatial television remote control;
displaying internet content regarding the area of interest based on the input from the television remote control;
navigating the internet content with the television remote control; and
providing inputs from the user to an internet site from the television remote control.

24. The method of claim 23, further comprising using radio frequency signals to transmit from the television remote.

25. The method of claim 23, further comprising using infrared signals to transmit from the television remote.

26. The method of claim 23, further comprising using an optical sensor to determine where the television remote is pointing.

27. The method of claim 23, further comprising using a sensor bar to determine where the television remote is pointing.
